(19) United States
(12) Patent Application Publication
(10) Pub. No.: US 2025/0236028 A1
(43) Pub. Date: Jul. 24, 2025

(54) MEASURING GRIPPER UNIT AND STRETCHING UNIT

(71) Applicant: BRÜCKNER MASCHINENBAU GmbH, Siegsdorf (DE)

(72) Inventors: Thomas HOFMANN, Grabenstätt (DE); Andrei DOUZHYK, Siegsdorf (DE); Silvio BARTH, Siegsdorf (DE); Kilian LACHNER, Traunreut (DE)

(21) Appl. No.: 19/030,093

(22) Filed: Jan. 17, 2025

(30) Foreign Application Priority Data
Jan. 19, 2024 (DE) 10 2024 101 555.1

(51) Int. Cl. B25J 19/02; B25J 11/00; B25J 13/08; B29C 55/20

(52) U.S. Cl. CPC B25J 19/028; B25J 11/005; B25J 13/087; B25J 19/027; B29C 55/20

(57) ABSTRACT

A measuring gripper unit is disclosed having a base body, at least one guide element and at least one clamping device. The clamping device is arranged on the base body and configured to clamp a material web. The guide element is also located on the base body and configured to guide the measuring gripper unit on a guide rail. Furthermore, the measuring gripper unit includes a sensor device which is configured to capture measurement data during the operation of the measuring gripper unit 100 in a stretching unit.

### CROSS REFERENCE TO RELATED APPLICATION

This application claims priority to German Patent Application Number DE 10 2024 101 555.1, filed Jan. 19, 2024, the entire contents of which is hereby incorporated by reference.

### BACKGROUND

The present disclosure relates to a measuring gripper unit for capturing measurement data during operation of a stretching unit, a stretching unit as well as a method for capturing measurement data in a stretching unit.

Stretching units are used in particular in the production of plastic films. Normally, the material web to be stretched, in general a plastic film, is gripped in such units by means of gripper units and moved through the stretching unit. The gripper units are guided and arranged displaceably on encircling guide rails and are driven centrally or individually.

During the actual stretching action, large forces act on the gripper units so that these are subject to extremely high loads and thus wear and tear. Thus, special load requirements are placed on the gripper units.

Another important component of a stretching unit is what is termed the transport system, which comprises, among other things, the guide rails and a drive system. In any case, the guide rails are located completely or in part in an oven. This enables the material web (in particular a plastic film) to be temperature controlled before and/or during the stretching (in particular to be heated up or to be maintained at a desired temperature).

The encircling guide rails guide the gripper units on a path of motion. The drive system(s) drive the gripper units on the guide rails. To this end, the gripper units can comprise chain links and/or be connected to each other into a chain strand via chain links.

To achieve a stretching of the material web that is as trouble-free as possible, it is important, among other things, that the friction between the guide rail and the gripper units is as small and uniform as possible. In reality, the friction fluctuates however locally. These fluctuations are due to various influencing factors, such as an unevenness of the guide rails (e.g. on the rail joints), deformations on the guide rails and/or local differences in roughness (for example caused by wear and tear).

Some of these influencing factors first occur after the stretching unit is already in operation, e.g. by heating the oven, through subsidence on the base of the stretching unit and/or by wear and tear on the guide rails. In addition, the friction is dependent on the process parameters that prevail when stretching the material web. This includes, among other things, the speed of the material web, temperatures, stretching forces, thickness of the material web, etc.

To detect any changes occurring in the stretching unit early on, in particular changes in friction, it is known to monitor the power (drive power) of the drive systems. If there is an increase in the power, this indicates increasing wear and tear as well as greater friction. Using this monitoring, it is not possible however to restrict the change locally.

### SUMMARY

The disclosure encompasses to detect and localize changes occurring on the stretching unit, in particular friction between the guide rail and gripper units. Moreover, the disclosure can be used to detect process parameters, such as temperature or tensile force of the material web, in order to thus optimise the stretching process.

This object is solved by a measuring gripper unit according to claim 1, by a stretching unit according to claim 13 and by a method according to claim 17. Further aspects of the disclosure are specified in the dependent claims and in the following description.

In particular, the object is solved by means of measuring gripper unit for a stretching unit. The stretching unit can be, for example, a transverse direction orienter, a machine direction orienter and/or a simultaneous stretching unit.

The measuring gripper unit comprises a base body, at least one guide element and at least one clamping device.

The clamping device is located on the base body. For example, the clamping device can be designed integrally with the base body at least in part or can be fixed in position on the base body. In one aspect, the clamping device is fastened with a threaded fastener, welded, riveted and/or fixed in position on the base body in another way.

Said at least one clamping device is configured to clamp a material web (for example a plastic film to be stretched). In particular, the clamping device can clamp a material web before or in an entry zone of the stretching unit. The clamping can be detached in or after an exit zone of the stretching unit, i.e. if the material web has been transported through the stretching unit by means of the gripper units and measuring gripper units.

In particular, the clamping device comprises at least one blade flap that is pivotally attached to the base body. The pivotable blade flap can interact with a clamping face of the base body in order to clamp the material web between the blade flap and the clamping face.

Said at least one guide element is located on the base body and is configured to guide the measuring gripper unit on a guide rail. The guide element can be designed integrally with the base body or can be attached to this (directly or indirectly). For example, the guide element is connected positively to the base body. In one example, the guide element is a slide element (e.g. a sliding block) which can be inserted into a corresponding receiving space of the base body positively. In another example, the guide element is a guide roller that rolls on a guide rail of a stretching unit.

In particular, multiple guide elements can be provided and/or the guide element can be shaped (for example U-shaped) in such a way that the guide element(s) are supported on at least two (preferably at least three or four) sides of the guide rail to guide the measuring gripper unit on a guide rail.

The measuring gripper unit comprises in addition a sensor device that is configured to capture measurement data during operation of the measuring gripper unit in a stretching unit.

As the measuring gripper unit is configured to clamp the material web and to be guided on the guide rail of the stretching unit-like the other gripper units of the stretching unit, the sensor device can capture measurement data with a local reference. This means the measurement data can be assigned to a position on the guide rail. Thus, for example, changes in the stretching unit that occur, in particular changes in friction, can be detected and limited early on and locally.

In particular, for the purpose of evaluation, the measurement data can also be compared with process parameters, such as current conveying speed, temperature, material web thickness and/or type of material. Thus, process parameters that, for example, influence friction, can be taken into account when determining changes that have occurred. Consequently, for example, it is possible to differentiate as to whether the measured changes (for example the friction) result from wear and tear, or from a (desired) change in the process parameters.

In particular, the condition of the guide rail(s) and the (measurement) gripper units can be inferred from the captured measurement data. For example, if the detected forces acting on the measuring gripper unit in the direction of travel or the transverse direction increase independently of a position of the measuring gripper unit on the running rail, this suggests general wear and tear of the gripper units or the running rail. If a local increase in the detected forces acting on the measuring gripper unit in the direction of travel are detected, local damage and/or contamination of the running rail can be inferred.

In one aspect, the measuring gripper unit can be built into a stretching unit simply. To this end, a conventional gripper unit of the stretching unit is replaced by the measuring gripper unit. The replacement can occur rapidly (e.g. in a few minutes) so that existing units can also be measured by means of at least one measuring gripper unit. In addition, lengthier outage times are thus avoided.

In addition, the measuring gripper unit can comprise an energy storage device. The energy storage device can supply the sensor device with electrical energy in order to capture measurement data. The energy storage device can be, for example, a battery or an accumulator. Additionally or alternatively, the measuring gripper unit can comprise a generator to provide electrical energy for supply to the sensor device. The generator can comprise, for example, an inductance coil, in which electrical energy is inducted due to the movement of the measuring gripper unit. In another aspect, for example, a roller can be connected to an electrical generator to convert rotational energy of the roller into electrical energy.

The measurement data captured by the sensor device (in particular, forces acting on the measuring gripper unit and/or accelerations, temperatures and/or suchlike) can be stored and/or sent after being captured.

To this end, the sensor device can comprise a data storage unit for storing the captured measurement data and/or a transmitter unit for wireless sending of the captured and/or stored measurement data.

The data storage unit can be, for example, an SSD, HDD or a flash memory (such as a SD card, a USB stick) or suchlike. The size of the storage can be dimensioned in such a way that measurement data can be stored for several hours, days or even weeks. This data storage unit can be removed and read, and/or the stored data can be transmitted wirelessly.

The transmitter unit can be configured for permanent transmission of the captured and stored measurement data. In this case, receiver antennae that can receive the sent data can be located along the guide rails.

The storage of the captured measurement data allows the data to be sent only at certain times. Thus, no permanent wireless communication connection is necessary. For example, the measurement data can be transmitted if the measuring gripper unit is located outside of an oven of the stretching unit and/or the stretching unit is at a standstill or operating at a slow speed. The installation of antennae or receiving units in the oven can therefore be eliminated.

In particular, the sensor device can also be configured to receive signals, such as control signals. For example, a control signal can initiate or end a measurement, or it can order the transmission of the captured data. Similarly, it is possible using control signals to order the renewed transmission of data that has not been received correctly. Furthermore, the capture itself can be controlled via control signals. To this end, for example, sensors of the sensor device can be selected and/or a scan rate can be set.

In one aspect, the sensor device comprises at least one of the following sensors: a temperature sensor, a force sensor, in particular a strain gauge, or a piezoelectric sensor, an acceleration sensor, a Hall-effect sensor and/or suchlike.

If several, preferably different sensors are used, the corresponding captured data can be set in correlation to each other (sensor fusion). This enables a detailed and/or reliable determination of the unit and/or process parameters.

For example, the condition of the guide rails or the gripper units can be inferred from the captured measurement data. To this end, for example, different forces can be detected.

In particular, the sensor device can be configured to detect a force acting on said at least one guide element (in particular in a direction of travel L and/or in a direction P that is transverse to the direction of travel of the measuring gripper unit (transverse direction)).

In an example, a force on the measuring gripper unit on the direction of travel L (for example, what is termed the chain longitudinal force) is measured. This force is a measure of the local friction and can be detected, for example, by means of a strain gauge.

In addition, a force in a direction P transverse to the direction of travel L of the measuring gripper unit (in particular a compressive force) can be determined preferably acting between the guide rail and the guide element.

Said at least one guide element can comprise a slide element or a guide roller. In the case of a slide element, a compressive force sensor (for example, a piezoelectric sensor) can be arranged on one of the sides of the slide element facing away from the guide rail. For example, the compressive force sensor can be arranged between the base body and the slide element. The compressive force sensor can be configured to detect a force in a direction P transverse to the direction of travel L of the measuring gripper unit.

In the case of guide rollers, radial and/or axial forces on the guide roller or its axle can be detected. The radial and/or axial forces can be detected for example using at least one strain gauge.

These compressive force sensors as well as radial and/or axial force sensors can detect fluctuations in the normal force between the guide element and the guide rail. This can indicate unevenness in the guide rail and/or contaminations.

Furthermore, the measuring gripper unit can comprise at least one sensor (e.g. a strain gauge) which detects a tensile force of a clamped material web (in particular film) on the clamping device. Thus, the stretching process can be monitored.

Similarly, the temperature on the gripper unit, in particular in the region of the guide rail and/or in the region of the clamping device, can be measured (by means of at least one temperature sensor). Like the detection of the tensile force, the detection of temperature(s) allows conclusions to be drawn about the stretching process. Thus, any process parameters, such as temperatures in various regions of the oven, blow-out speeds, material web speed, material web thicknesses, stretching conditions, etc., can be set or adjusted (in particular controlled).

In one aspect, the measuring gripper unit can be configured to be accelerated and/or decelerated by a drive system (in a particular a linear motor) of a stretching unit.

In another aspect, the base body is configured to be connected to a chain link. In particular, the base body can be connected positively to a chain link of a chain strand of a drive system of a stretching unit. To this end, the base body can comprise a coupling means and the chain link a corresponding coupling means. Via the coupling means, the base body can thus be connected to the chain link positively. By means of the chain strand, the measuring gripper unit can be driven, in particular accelerated and/or decelerated.

In a further aspect, the measuring gripper unit comprises at least one chain link. This chain link can be attached to the base body fixedly (for example, positively), or be designed integrally with the base body. The chain link of the measuring gripper unit can be connected to at least one further chain link in order to be integrated in a chain strand of a drive system of a stretching unit. Similarly, the measuring gripper unit can comprise multiple chain links, wherein at least one chain link is connected to the base body.

The sensor device can be configured to detect a force acting on said at least one chain link, in particular in a direction of travel L (chain longitudinal force), and/or a force acting in a direction P transverse to a direction of travel L of the measuring gripper unit. The corresponding chain link can be a chain link which is connected to the base body, and/or which is connected to the chain link that is connected to the base body.

In particular, the chain link can be an inner chain link or an outer chain link. In one aspect, an outer chain link is connected to the base body and an inner chain link is connected the outer chain link, wherein the inner chain link and the outer chain link are integrated into a chain strand of a drive system of a stretching unit or are able to be integrated.

In particular, the external contour of the measuring gripper unit corresponds substantially to an external contour of a typical gripper unit of a stretching unit so that further modifications are not necessary when installing the measuring gripper unit in the stretching unit and there is no risk of collisions with other parts of the stretching unit. As a result, the capture of measurement data can be started directly after the installation of the measuring gripper unit-without time- consuming adaptations or deconstructions of parts of the stretching unit, such as the oven or the drive system.

In particular, at least one force sensor can be arranged on a chain link (for example for capturing the chain longitudinal force). In one aspect, a first force sensor is arranged on a first link plate of the chain link (for example an upper link plate) and/or a second force sensor is located on a second link plate of the chain link (for example on a lower link plate). Consequently, the chain longitudinal force can be determined very exactly. The chain link can be in particular an inner chain link.

Furthermore, the sensor device can comprise a timer. Thus, the sensor device can be configured to capture, to store and/or to send a chronological course of the measurement data. In particular, the course of the measurement data can be sent during operation of the measuring gripper unit. For example, the course of the measurement data can be transmitted if the measuring gripper unit is located outside of an oven of the stretching unit and/or the stretching unit is at a standstill or operating at a slow speed.

If the sensor device comprises a Hall-effect sensor or a similar sensor, a magnetic field of at least one fixed magnet can be detected at a specific time, at said time the measuring gripper unit on the guide rail is guided past the magnet. Through the time of capturing the magnetic field and the knowledge of where the magnet is located, the chronologically captured measurement data can be assigned to a position of the measuring gripper unit on the guide rail. Detected changes in the measurement data can thus be localised very exactly.

For example, the sensor device is configured to capture measurement data with a frequency of at least 2 kHz, or at least 2.5 kHz, or at least 3 kHz.

For example, at a material web speed of 700 m/min, a resolution of ca. 5 mm is yielded at a measurement frequency of 2.5 kHz.

Furthermore, the sensor device can be configured to capture at least 4, at least 8, at least 12, at least 16 or at least 32 different measurement data parallelly or to read sensors. To this end, corresponding A/D converters and/or measurement data amplifiers are provided. The sensors can also be read sequentially. The measurement frequency can be reduced accordingly in order to not diminish the resolution.

In one aspect, the sensor device is a temperature-resistant sensor device. This can be attained through the use of corresponding temperature-resistant materials, through the provision of cooling and/or through thermal insulation, in particular the electronics and/or the sensor device. In particular, the temperature-resistant sensor device can be configured to capture measurement data during operation of the measuring gripper unit in the stretching unit, wherein the operating temperature of the stretching unit amounts to at least 200° C., or at least 300° C. or at least 400° C.

Furthermore, the object is solved by a stretching unit, in particular a transverse direction orienter, a machine direction orienter and/or a simultaneous stretching unit, said stretching unit comprising at least one guide rail and at least one of the measuring gripper units described previously. Said at least one measuring gripper unit is guided on the guide rail by means of a guide element. Thus, it can be transported through the stretching unit and, at the same time, clamp a material web to be stretched-by means of the clamping device. Consequently, measurement data can be captured in production operations of the stretching unit. The captured measurement data can be used for the optimisation and/or control of the stretching unit, in particular its process parameters.

The stretching unit comprises at least one magnet which is located in the region of at least one guide rail. The measuring gripper unit of the stretching unit can be configured to detect a magnet field of at least one magnet at a point of time, at said point of time the measuring gripper unit on the guide rail is guided past the magnet. Through the point of time of capturing the magnetic field and the knowledge of where the magnet is located, the chronologically captured measurement data can be assigned to a position of the measuring gripper unit on the guide rail. Detected changes in the measurement data can thus be localised very exactly.

In a further aspect, the stretching unit comprises at least one receiving unit. The receiving unit can be configured to receive measurement data from the measuring gripper unit, wherein the receiving unit is located in particular outside of a stretching oven.

Furthermore, the stretching unit can comprise different types of measuring gripper units. A first type can be configured to capture a first measurement data type and a second type to capture a second measurement data type, wherein the first and the second measurement data types differ. For example, the first measuring gripper unit can detect forces acting on the measuring gripper unit and a second measuring gripper unit can detect temperatures acting on the measuring gripper unit. The captured measurement data of both measuring gripper units can then be assigned to a position on the guide rail and thus placed in correlation to each other.

The object is solved furthermore by a method for capturing measurement data in a stretching unit, wherein the method comprises the following:
arrangement of at least one measuring gripper unit on a guide rail of a stretching unit;
guiding of said at least one measuring gripper unit along the guide rail, wherein the measuring gripper unit optionally clamps a material web;
capturing of measurement data by means of a measuring gripper unit; and
storing and/or wireless sending of the captured measurement data, wherein the sending occurs during and/or after the guiding.

Furthermore, the method can comprise the assignment of the captured measurement data to a position on a guide rail of the stretching unit, as well as control of the stretching unit based on the captured measurement data.

### BRIEF DESCRIPTION OF THE DRAWINGS

Additional features and advantages of the disclosure are found in the attached figures and the corresponding description of the figures. In the figures,

FIG. 1 shows a schematic view of a first embodiment of a stretching unit according to an exemplary embodiment,

FIG. 2 shows a schematic view of a second embodiment of a stretching unit according to an exemplary embodiment,

FIG. 3 shows a schematic view of a measuring gripper unit and a receiving unit,

FIGS. 4A, and 4B show perspective views of a first embodiment of a measuring gripper unit according to an exemplary embodiment,

FIGS. 5A and 5B show perspective views of a second embodiment of a measuring gripper unit according to an exemplary embodiment, and

FIG. 6 shows a detailed view of an axle of a guide roller.

### DETAILED DESCRIPTION

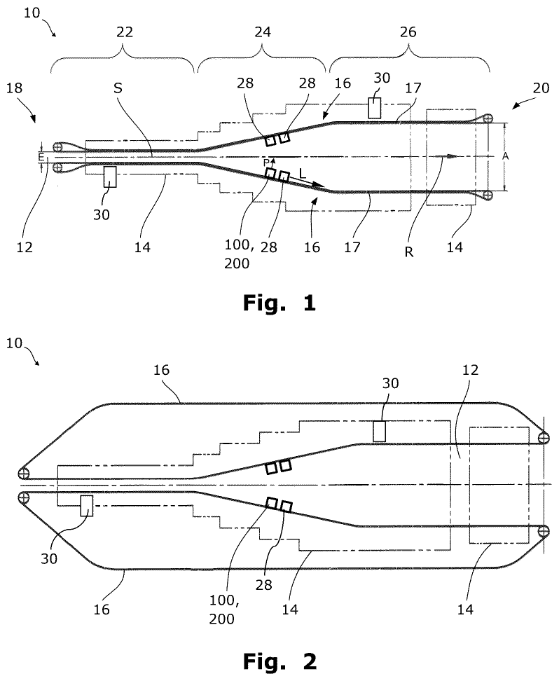

FIG. 1 shows a stretching unit 10. This comprises an oven 14 as well as two drive systems 16.

The drive systems 16 are located mirror- symmetrically with respect to a symmetry axis S of the stretching unit 10 and extend at least in part into the oven 14. The drive systems 16 run outside of the oven 14 in an entry zone 18 as well as an exit zone 20, in which the material web 12 of the stretching unit 10 is fed and removed.

In addition to the entry zone 18 and the exit zone 20, the stretching unit shown here has at least three further zones 22, 24, 26.

The zones 22, 24, 26 adjoin each other so that, as seen along the usual direction of travel and drawing direction R of the stretching unit 10, the entry zone 18 initially adjoins the first zone 22 that then adjoins the second zone 24 that then adjoins the third zone 26 that finally adjoins the exit zone 20.

The drive systems 16 have a first spacing from each other in the first zone 22 of the stretching unit 10 which adjoins the entry zone 18, said first zone 22 also being termed the preheating zone.

In the second zone 24, also termed the stretching zone, the spacing of both drive systems to each other increases until finally at the start of the third zone 26, also termed the heat treatment zone, a second spacing is attained.

Each of the drive systems 16 has a guide rail 17 in the known manner, on which a multitude of gripper units 28 are guided. The gripper units 28 can be moved along the guide rail 17 by means of a drive of the respective drive system 16.

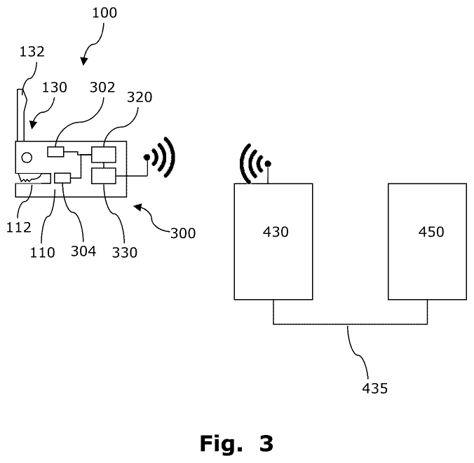

In FIGS. 1 and 2, only two gripper units 28 per drive system 16 are each shown symbolically. However, the stretching unit 10 comprises more gripper units 28. In addition, one or more measuring gripper units 100, 200 can be guided on the guide rail 17. The gripper units 28 and the measuring gripper units 100, 200 differ from each other substantially through the presence of a sensor device for capturing measurement data. A potential design of the measuring gripper unit 100, 200 is shown in the FIGS. 3 to 5B.

The guide rails 17 of the respective drive systems 16 circle a closed path from the entry zone 18 to the exit zone 20 and back again. The guide rail section forming the forward travel extends in the intended direction of travel of the gripper units 28 between the entry zone 18 and the exit zone 20 within the oven 14.

The guide rail section that runs from the exit zone 20 to the entry zone 18 in the normal operating direction and forms the return is also located within the oven 14 in the shown embodiment. As shown in the embodiment according to FIG. 2, it can also however be located outside the oven 14.

To operate the stretching unit 10, the material web 12 to be stretched, for example a plastic film, is fed into the entry zone 18 of the stretching unit 10 in the drawing direction R. To this end, the material web 12 is attached to both drive systems 16 by means of its edges running in the drawing direction R.

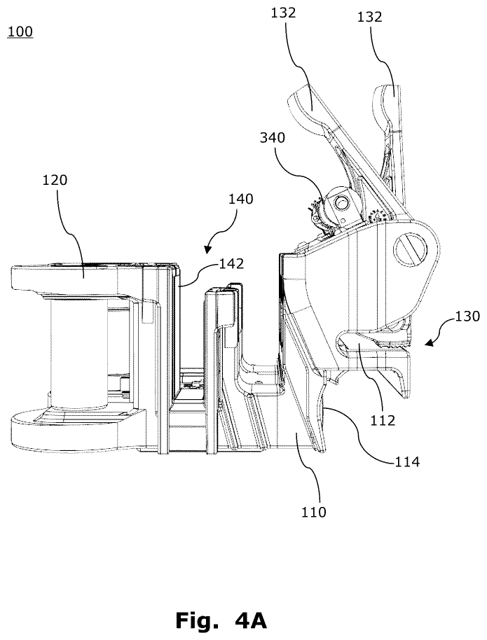

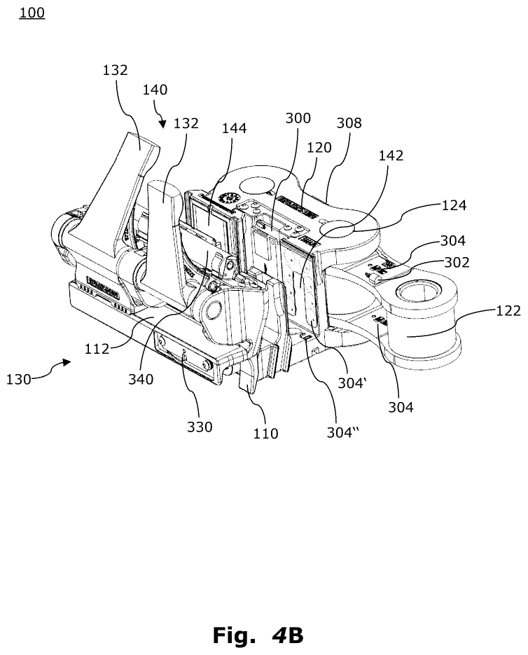

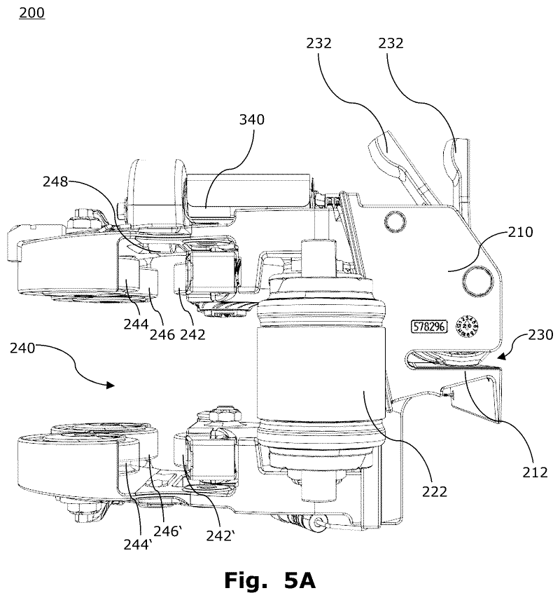

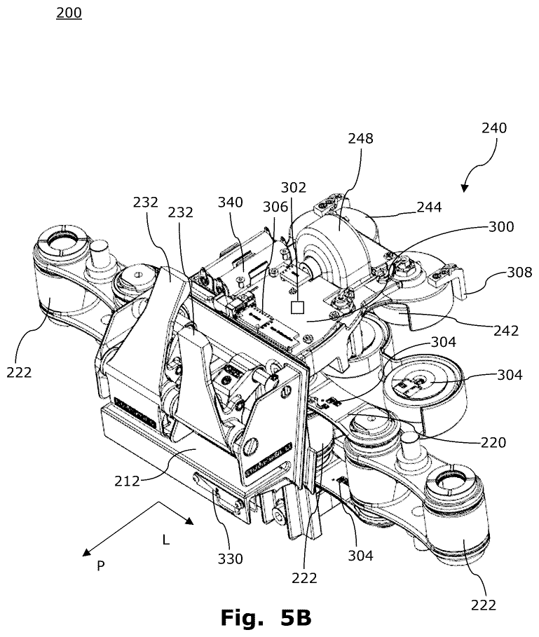

More specifically, the edges of the material web 12 are clamped by a clamping device 130, 230 (see FIG. 4A and 5A) of the gripper units 28 or the measuring gripper unit 100, 200 and thus are moved by the movement of the (measuring) gripper units 28, 100, 200 along the guide rails 17 of the drive systems 16.

In the entry zone 18, the material web 12 has a width E perpendicular to the drawing direction R that corresponds approximately to the first spacing between the drive systems 16.

The material web 12 is then fed through the first zone 22 and heated there. In the next second zone 24, thus the stretching zone, the material web 12 is stretched as the spacing of the drive systems 16 is increased continuously. At the end of the second zone 24, the material web has a second width A.

After completing the stretching, the material web 12 now passes through the third zone 26, in which a relaxation of the material web 12 can take place before the material web 12 is detached from the gripper units 28, 100, 200 in the exit zone 20 and leaves the stretching unit 10 with a width A.

For example, the stretching unit 10 is a width-wise film stretching unit or transverse direction orienter, also referred to in short as a TDO (TDO=transverse direction orienter).

It is also conceivable that the stretching unit 10 is a simultaneous stretching unit, in which the material web 12 can be stretched in the second zone 24, thus the stretching zone, not only in the direction transverse to the drawing direction R but also in the drawing direction R.

During the processing of the material web 12, large tensile forces act on the gripper units 28 in a tensile direction, above all in the second zone 24, thus the stretching The direction zone. tensile is predominantly in a primary direction P of the gripper units 28 and to a lesser extent transverse to the primary direction P.

Thus, the gripper units 28 must be designed to withstand high tensile forces, in particular in their primary direction P. The primary direction P is thus that horizontal direction that runs transversely to an edge of the material web 12 received in the gripper unit 28. The primary direction P is substantially normal to a direction of travel L of the (measuring) gripper units, which is predetermined by the layout of the guide rails.

The stretching unit 10 comprises at least one magnet 30. The magnet 30 is located in the region of said at least one guide rail 17. If a measuring gripper unit is guided past the magnet 30, the magnet field of at least one magnet 30 can be detected. Via the point of time of the detection of the magnetic field, further measurement values can be assigned to a position on the guide rail.

FIG. 3 shows a schematic representation of a measuring gripper unit 100 and a receiving unit 430, which is connected to an evaluation unit 450 via a wired connection or wirelessly via a communication connection 435. The measuring gripper unit 100 comprises a clamping device 130 that is configured to clamp a material web.

In particular, the clamping device 130 comprises at least one blade flap 132 that is pivotally mounted on the base body 110. The pivotable blade flap 132 can interact with a clamping face 112 of the base body 110 in order to clamp the material web between the blade flap 132 and the clamping face 112. In particular, the clamping device 130 is designed like the gripper unit 28. Thus, the material web can be clamped completely.

Furthermore, the measuring gripper unit 100 comprises a sensor device 300 which is configured to capture measurement data, such as forces, accelerations, temperatures and/or magnetic fields during the operation of the measuring gripper unit 100 in a stretching unit.

The sensor device can comprise different sensors. Here, as an example, a temperature sensor 302 and a force sensor 304 are shown. The captured measurement data can be transmitted via a A/D converter and/or an amplifier and then be stored by means of a data storage unit 320 (e.g. comprising an SSD, HDD or a flash memory, such as a SD card, a USB stick, or suchlike). The captured and/or stored measurement data can be sent via a transmitter unit 330 and received by a receiving unit 430 (which is not part of the measuring gripper unit).

As shown in FIGS. 4B and 5B, an antenna of the transmitter unit 330 can be arranged on the measuring gripper unit in such a way that this points in the direction of the material web. The data received by the receiving unit can then be transmitted to an evaluation unit 450.

Alternatively or additionally, the transmission of the data can also occur through the removal of a mobile data storage device (such as a SD card) from the data storage unit 320. The data stored on the mobile data storage device can then be read (by means of a laptop), stored and transmitted to the evaluation unit 450.

Furthermore, this data can be used for optimizing process parameters, in particular for the control of the stretching unit.

In FIGS. 4A and 4B, a measuring gripper unit 100 is shown in various views exemplarily.

The measuring gripper unit 100 comprises a base body 110, a guide element 140 and at least one clamping device 130. The clamping device 130 is arranged on the base body 110 and configured to clamp a material web. In particular, a material web can be clamped between blade flaps 132 arranged pivotably and a clamping face 112 of the base body 110.

The guide element 140 is also located on the base body 110 and configured to guide the measuring gripper unit 100 on a guide rail of a stretching unit.

In the embodiment shown here (see FIG. 4B) of the measuring gripper unit 100, the base body 110 is connected to a chain link 120 positively, wherein the chain link 120 can be connected to a chain link of a chain strand of a drive system of a stretching unit.

For example, the base body 110 is fastened by means of threaded fasteners 114 to the chain link 120. The chain link 120 (here an outer chain link) is connected in turn to an inner chain link 122 via a pin 124.

The guide element 140 comprises here multiple slide elements 142, 144. In particular, the guide element 140 can be designed U-shaped and can thus encompass a guide rail or slide rail. The slide elements 142, 144 slide on the guide rail (not shown) and thus guide the measuring gripper unit 100 on the guide rail.

In FIG. 4A, an energy storage device 340 is also shown, for example an accumulator or a (high-temperature) battery, which supplies energy to a sensor device 300. Here, the energy storage device is arranged behind the blade flaps 132 (as seen from the material web).

In FIG. 4B, the measuring gripper unit 100 from FIG. 4A is shown again, however in another view. The sensor device 300, in particular the electronics of the sensor device, including A/D converter, amplifier and a data storage unit, is arranged on the chain link 120, in particular between two slide elements 142, 144.

The sensor device 300 comprises different sensors. Here, as an example, a temperature sensor 302, different force sensors 304, 304′, 304″ and a Hall-effect sensor 308 are shown. A (tri-axial) acceleration and/or yaw-rate sensor can be arranged on a mainboard (for example a PCB) of the sensor device 300. The provision of further sensors, in particular pressure sensors and/or distance sensors is also possible. As is described in more detail in relation to FIG. 5B, the measuring gripper unit can also comprise temperature sensor(s) and/or acceleration sensor(s) as well as further sensors.

In particular, the sensor device 300 can be configured to detect a force acting on at least the guide element 140 (in particular in a direction of travel L and/or in a direction (P) that is transverse to the direction of travel L of the measuring gripper unit).

The guide element 140 comprises slide elements 142, 144. A compressive force sensor (for example a piezoelectric sensor 304′) can be arranged under these slide elements, i.e. on the side facing away from the guide rail. The compressive force sensor 304′ can comprise a sensor array that not only detects a compressive force on the slide element 142, but also captures a 2-D image of the compressive forces acting on the slide element 142.

The sensor array can also be configured to detect a total force, in particular a total compressive force. To this end, the individual sensors of the sensor array can be connected accordingly.

To determine the tensile forces acting on the chain links 122, 120, a first force sensor 304 can be arranged on a first (upper) link plate of the chain link 122 and a second force sensor 304″ can be arranged on a second (lower) link plate of the chain link 122.

Furthermore, the measuring gripper unit 100 can comprise at least one sensor 304″ (e.g. a strain gauge, not shown) which detects a tensile force of a clamped material web (in particular film) on the clamping device 130. Thus, the stretching process can be monitored.

As shown in FIG. 4B, the sensor device 300 can be configured to detect a force acting on at least one chain element 122, in particular in a direction of travel L (chain longitudinal force), and/or a force acting in a direction P that is transverse to a direction of travel L of the measuring gripper unit 100. The chain link 122 comprises to this end a force sensor 304 on a first link plate of the chain link (here the upper link plate). In addition, a further force sensor 304 is arranged on a lower, second link plate of the chain link 220.

In FIGS. 5A and 5B, a measuring gripper unit 200 is shown in various views exemplarily. The measuring gripper unit 200 comprises a base body 210, a guide element 240 and at least one clamping device 230. The clamping device 230 is arranged on the base body 210 and configured to clamp a material web. In particular, a material web can be clamped between blade flaps 232 arranged pivotably and a clamping face 212 of the base body 210.

The guide element 240 is also located on the base body 210 and configured to guide the measuring gripper unit 200 on a guide rail of a stretching unit.

The guide element 240 comprises here multiple guide rollers 242, 244, 246, 248, 242′, 244′ and 246′. These guide rollers can receive a guide rail between them and support thus in such a way on the guide rail that the measuring gripper unit 200 is guided on the guide rail.

Furthermore, the base body 210 is connected positively to an inner chain link 222, which in turn attaches to a further inner chain link 222 via an outer chain link 220 (see FIG. 5B).

In FIG. 5A and 5B, an energy storage device 340 is also shown, for example an accumulator or a (high-temperature) battery, which supplies energy to a sensor device 300.

In FIG. 5B, the measuring gripper unit 200 from FIG. 5A is shown again, however in another view. The sensor device 300, in particular the electronics of the sensor device, including A/D converter, amplifier and a data storage unit, are arranged on a side of the clamping device 230 that faces away from the material web during operation.

The sensor device 300 comprises different types of sensors. Here, a temperature sensor 302, multiple force sensors 304, in particular strain gauges, an acceleration sensor 306 (for example a tri-axial rotational and acceleration sensor) and two hall-effect sensors 308 are shown exemplarily.

In particular, the sensor device 300 can be configured to detect one or more forces acting on the guide element 240 (in particular in a direction of travel L and/or transverse to the direction of travel of the measuring gripper unit).

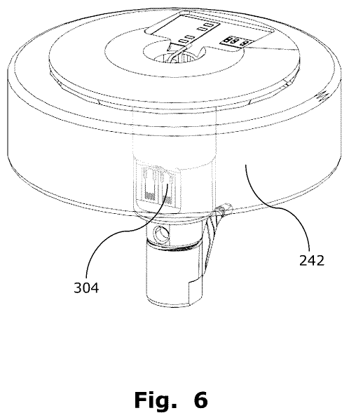

As explained in relation to FIG. 5A, the guide element 240 comprises multiple guide rollers 242-248. As shown in particular in FIG. 6, force sensors 304, in particular strain gauges, can be located on an axle of the guide rollers 242-248 in order to detect radial and/or axial forces on the guide roller and their axles.

These radial and/or axial sensors can detect fluctuations in the normal force between the guide element 240, in particular the guide rollers and a guide rail.

Furthermore, the measuring gripper units 200 can comprise at least one sensor (e.g. a strain gauge, not shown) which detect at least one tensile force of a clamped material web (in particular film) on the clamping device 230. Said at least one tensile force is transmitted via the guide rollers 244 and 246 which absorb corresponding tensile forces. Thus, the stretching process can be monitored.

Similarly, the temperature at the gripper unit can be detected (by means of a temperature sensor 302, which is located on the base body 210 here exemplarily. Similarly, the temperature can also be detected at the temperature at the rollers and/or the chain links. To this end, corresponding temperature sensors are arranged at the relevant points of measurement.

As shown in FIG. 5B, the sensor device 300 can be configured to detect a force acting on at least one chain element 220, in particular in a direction of travel L (chain longitudinal force), and/or a force acting in a direction P that is transverse to a direction of travel L of the measuring gripper unit. The chain link 220 comprises to this end a force sensor 304 on a first link plate of the chain link (here the upper link plate). In addition, a further force sensor 304 is arranged on a lower, second link plate of the chain link 220.

In particular, the external contour of the measuring gripper units 100, 200 correspond substantially to an external contour of a typical gripper unit of a stretching unit 10 so that further modifications are not necessary when installing the measuring gripper units 100, 200 in the stretching unit and there is no risk of collisions with other parts of the stretching unit.

Preferably, the measuring gripper units 100, 200 comprise just as many blade flaps 232 as the standard gripper units 28 used in the stretching unit (i.e. two blade flaps 232 here). This enables the material web to be clamped with the measuring gripper unit in the same way as with a standard gripper unit 28 so that a uniform, proper clamping of the material web can occur over the transport path of the material web. This ensures a realistic measurement of the tensile force acting on the material web.

1. A measuring gripper unit for a stretching unit, comprising:
a base body, at least one guide element and at least one clamping device,
wherein at least one clamping device is arranged on the base body and configured to clamp a material web;
wherein at least one guide element is arranged on the base body and is configured to guide the measuring gripper unit on a guide rail; and
wherein the measuring gripper unit comprises a sensor device which is configured to capture measurement data during the operation of the measuring gripper unit in a stretching unit.

2. The measuring gripper unit according to claim 1, wherein the sensor device comprises a data storage unit for storing the captured measurement data and/or a transmitter unit for wireless sending of the captured and/or stored measurement data.

3. The measuring gripper unit according to claim 1, wherein the sensor device comprises at least one of the following sensors:
a temperature sensor,
a force sensor, a strain gauge, or a piezoelectric sensor,
an acceleration sensor,
a hall-effect sensor.

4. The measuring gripper unit according to claim 1, wherein the sensor device is configured to detect a force acting on said at least one guide element, in a direction of travel (L) and/or in a direction (P) that is transverse to the direction of travel (L) of the measuring gripper unit.

5. The measuring gripper unit according to claim 1, wherein said at least one guide element comprises a slide element or a guide roller.

6. The measuring gripper unit according to claim 5, wherein
the sensor device comprises at least one compressive force sensor, in particular a piezoelectric sensor, and wherein
the compressive force sensor is arranged between the base body and the slide element, and is configured to detect a force in a direction (P) that is transverse to the direction of travel (L) of the measuring gripper unit, or wherein
the sensor device comprises at least one force sensor, in particular a strain gauge, and wherein the force sensor is assigned to a guide roller and is configured to detect a radial force and/or an axial force.

7. The measuring gripper unit according to claim 1, wherein the sensor device is configured to detect a tensile force of a clamped material web on the clamping device.

8. The measuring gripper unit according to claim 1, wherein the base body is configured furthermore to be connected to a chain link and/or wherein
the measuring gripper unit comprises at least one chain link, wherein the base body is connected fixedly to at least one chain link, and wherein
the sensor device is configured to detect a force acting on said at least one chain element, in a direction of travel (L) and/or in a direction (P) that is transverse to a direction of travel (L) of the measuring gripper unit.

9. The measuring gripper unit according to claim 8, wherein at least one force sensor is arranged on the chain link, wherein
a first force sensor is able to be located on a first link plate of the chain link, and/or wherein
a second force sensor is able to be located on a second link plate of the chain link, wherein the chain link is in particular an inner chain link.

10. The measuring gripper unit according to claim 1, wherein the sensor device comprises furthermore a timer,
wherein the sensor device is configured to capture, to store and/or to send a chronological course of the measurement data, and
wherein the sensor device is configured to send the course of the measurement data during operation of the measuring gripper unit.

11. The measuring gripper unit according to claim 1, wherein the sensor device is configured to capture the measurement data with a frequency of at least 2 kHz or at least 2.5 kHz or at least 3 kHz and/or wherein the
sensor device is configured to capture at least four different measurement data parallelly.

12. The measuring gripper unit according to claim 1, wherein the sensor device is a temperature-resistant sensor device so that
the sensor device captures measurement data during operation of the measuring gripper unit in the stretching unit, wherein the operating temperature of the stretching unit amounts to at least 200° C. or at least 300° C. or at least 400° C.

13. A stretching unit, comprising a guide rail and at least one measuring gripper unit according to claim 1, wherein the measuring gripper unit is guided on the guide rail by means of the guide element.

14. The stretching unit according to claim 13, further comprising at least one magnet, said magnet being located in the region of said at least one guide rail, and wherein
the measuring gripper unit is configured to detect a magnet field of at least one magnet at a point of time, at said point of time the measuring gripper unit is guided past the magnet on the guide rail.

15. The stretching unit according to claim 13, wherein the stretching unit comprises at least one receiving unit, said receiving unit being configured to receive measurement data from the measuring gripper unit, wherein the receiving unit is arranged outside of a stretching oven.

16. The stretching unit according to claim 13, wherein
the stretching unit comprises different types of measuring gripper units, wherein a first type is configured to capture a first measurement data type and a second type to capture a second measurement data type, and wherein the first and the second measurement data types differ.

17. A method for capturing measurement data in a stretching unit, wherein the method comprises the following:
arrangement of at least one measuring gripper unit according to claim 1 on a guide rail of a stretching unit;
guiding of said at least one measuring gripper unit along the guide rail, wherein the measuring gripper unit optionally clamps a material web;
capturing measurement data by means of a measuring gripper unit; and
storing and/or wireless sending of the captured measurement data, wherein the sending occurs during and/or after the guiding.

18. The method according to claim 17, further comprising
an assignment of the captured measurement data to a position on a guide rail of the stretching unit, and/or
control of the stretching unit based on the captured measurement data.
